(19) United States
(12) Patent Application Publication
(10) Pub. No.: US 2008/0150450 A1
(43) Pub. Date: Jun. 26, 2008

(54) SYSTEMS AND METHODS FOR LED BASED LIGHTING

(75) Inventors: Timothy E. Starr, Sterling, MA (US); Teddy D. Thomas, Needham, MA (US); Michael P. Kosteva, Milford, MA (US); John J. Palczynski, Hopkinton, MA (US); Mark S. Pieper, Stow, MA (US)

Correspondence Address: TEXAS INSTRUMENTS INCORPORATED, P O BOX 655474, M/S 3999, DALLAS, TX, 75265, US

(73) Assignee: TEXAS INSTRUMENTS INC, Dallas, TX (US)

(21) Appl. No.: 11/671,907

(22) Filed: Feb. 6, 2007

Related U.S. Application Data
(60) Provisional application No. 60/871,201, filed on Dec. 21, 2006.

(51) Int. Cl. H05B 41/36

(52) U.S. Cl. 315/294

(57) ABSTRACT

Various systems and methods for lighting are disclosed. For example, some embodiments of the present invention provide methods for retrofitting lights. The methods include providing a solid state light bulb. The solid state light bulb includes: an LED array, a dimming control circuit, and a current regulator. The current regulator provides an LED current to the LED array. The LED current varies based on a control from the dimming control circuit. The methods further include, electrically coupling the solid state light bulb to an existing incandescent dimmer switch, and adjusting the existing incandescent dimmer switch such that the intensity of light emitted from the LED array is adjusted in proportion to the adjustment of the existing incandescent dimmer switch.

### CROSS REFERENCE TO RELATED APPLICATIONS

The present application claims priority to (is a non-provisional filing of) US Provisional Patent Application No. 60/871,201, entitled “SYSTEMS AND METHODS FOR LED BASED LIGHTING” and filed Dec. 21, 2006 by Starr et al. The aforementioned application is assigned to an entity common hereto and is incorporated herein by reference for all purposes.

### BACKGROUND OF THE INVENTION

The present invention is related to lighting, and more particularly, to systems and methods for LED based lighting.

Various approaches for lighting have been developed. The oldest and most common utilizes an incandescent light bulb which includes a filament disposed in an evacuated chamber. The temperature of the filament increases in proportion to a voltage applied to the filament. This causes the filament to glow, and thereby to generate light. While such an approach to lighting is effective, it suffers from various drawbacks. For example, filament based lights are typically unreliable as the filament tends to burn out over time. In addition, such filament based lights are often inefficient, and tend to cast a yellowish light. One advantage of incandescent lighting is that it is relatively easy to adjust the voltage being provided to the filament, and thereby adjust the intensity of the light output from the incandescent bulb.

Use of fluorescent lighting has prospered as an alternative to incandescent lighting. Fluorescent lighting typically involves the use of a gas filled chamber or tube. As a voltage is applied across the chamber, the gas within the chamber begins to luminesce. Fluorescent lighting is more efficient than incandescent lighting and typically offers better reliability. However, fluorescent lighting relies on Mercury that is detrimental to the environment, and some people do not like the light that is cast from fluorescent bulbs. As another disadvantage, it is somewhat complicated to adjust the light emitted from a fluorescent bulb through a dimming process.

Thus, for at least the aforementioned reasons, there exists a need in the art for advanced systems and methods for lighting.

### BRIEF SUMMARY OF THE INVENTION

The present invention is related to lighting, and more particularly, to systems and methods for LED based lighting.

Various systems and methods for lighting are disclosed. For example, some embodiments of the present invention provide methods for retrofitting lights. The methods include providing a solid state light bulb. The solid state light bulb includes: an LED array, a dimming control circuit, and a current regulator. The current regulator provides an LED current to the LED array. The LED current varies based on a control from the dimming control circuit. The methods further include, electrically coupling the solid state light bulb to an existing incandescent dimmer switch, and adjusting the existing incandescent dimmer switch such that the intensity of light emitted from the LED array is adjusted in proportion to the adjustment of the existing incandescent dimmer switch. In some cases, adjusting the existing incandescent dimmer switch causes the existing incandescent dimmer switch to output a voltage that varies up to 120 VAC.

Other embodiments of the present invention provide a backwards compatible solid state light bulb. Such light bulbs include an LED array, a dimming control circuit, and a current regulator. The current regulator provides an LED current to the LED array, and the LED current varies based on a control from the dimming control circuit. In some instances of the aforementioned embodiments, the dimming control circuit is operable to receive a voltage output from an incandescent dimmer switch and to provide the control based on the voltage output from the incandescent dimmer switch. In some cases, the control is a DC voltage that varies in proportion to the voltage output from the incandescent dimmer switch. In various cases, the DC voltage varies in direct proportion, while in other cases, the DC voltage varies in inverse proportion. In one particular instance of the aforementioned embodiments, the DC voltage varies between 0V and 10V. In various instances of the aforementioned embodiments, the bulb further includes a full wave bridge that rectifies the voltage output from the incandescent dimmer switch before the voltage output from the incandescent dimmer switch is provided to the dimming control circuit.

In other instances of the aforementioned embodiments, the control is a pulse width modulated output with a duty cycle that is proportional to the voltage output from the incandescent dimmer switch. In some cases, the LED array includes a plurality of serially connected LEDs. Such a serial configuration may be driven by a single current source. In one particular case, the plurality of serially connected LEDs is a series of sixteen LEDs.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a solid state light bulb in accordance with various embodiments of the present invention;

FIG. 2 is a schematic diagram of a full wave bridge that may be used in relation to one or more embodiments of the present invention;

FIG. 3 is a schematic diagram of a linear voltage regulator that may be used in relation to one or more embodiments of the present invention;

FIG. 4a is a schematic diagram of a switching current regulator that may be used in relation to on or more embodiments of the present invention;

FIG. 4b is an output diagram depicting the operation of the switching current regulator of FIG. 4a.

FIGS. 5a-5b are schematic diagrams of dimming control circuits that may be used in relation to various embodiments of the present invention;

FIG. 6 is an LED array that may be used in relation to different embodiments of the present invention; and

FIG. 7 is a flow diagram showing a method for retrofitting lighting in accordance with various embodiments of the present invention.

### DETAILED DESCRIPTION OF THE INVENTION

The present invention is related to lighting, and more particularly, to systems and methods for LED based lighting.

Light emitting diodes offer a promising approach for lighting as LEDs are typically more efficient and offer greater reliability than incandescent bulbs. Further, LEDs do not suffer from the environmental concerns of fluorescent bulbs. LED lighting can be formed of a number of LEDs arranged in serial or parallel, and mounted in a common package. The package may be designed for installation into existing incandescent lighting circuitry. However, in contrast to incandescent lights, LEDs emit light as a function of current. Thus, pre-existing incandescent dimmer circuitry will not operate to properly dim an LED based lighting package without appropriate signal conditioning. As used herein, the phrases “incandescent dimmer” or “incandescent dimmer switch” are used in their broadest sense to mean any type of dimmer switch that is designed for use in relation to incandescent illumination. Such switches are typically designed to provide a voltage output that varies. The varying voltage is applied to an incandescent light bulb which emits light as a function of voltage. In contrast, an LED emits light as a function of current. Similarly, as used herein, the phrases “incandescent circuitry” or “incandescent wiring” are used in their broadest sense to mean any circuitry designed to power or control incandescent lighting. Thus, for example, a home built before the advent of fluorescent lighting or LED lighting would typically include incandescent wiring and may include one or more incandescent dimmer switches. Based on the disclosure provided herein, one of ordinary skill in the art will recognize a myriad of incandescent circuitry, incandescent dimmer switches, and incandescent wiring with which one or more embodiments of the present invention may be used.

Some embodiments of the present invention provide an LED based lighting package that is compatible with existing incandescent dimmer circuitry. Said another way, some embodiments of the present invention provide solid state light bulbs that can be controlled by existing incandescent dimmer circuitry or switches. Such devices may be used to replace less reliable incandescent bulbs as they burn out, or they may be used to immediately replace existing incandescent bulbs as a power saving strategy. In some cases, such embodiments work off of 120 VAC nominal with a variance of ±20%, and provide light emission equivalent to a 40 W incandescent bulb when measured at a defined angle. In one particular instance of the aforementioned embodiments, the solid state light bulb uses sixteen LEDs that are connected in series. Each of the LEDs rely on a 350 mA current for maximum luminescence, and drop between three and four volts (3.2V typical). Based on the disclosure provided herein, one of ordinary skill in the art will recognize a variety of LEDs and numbers thereof that may be grouped to form a solid state light bulb in accordance with one or more embodiments of the present invention.

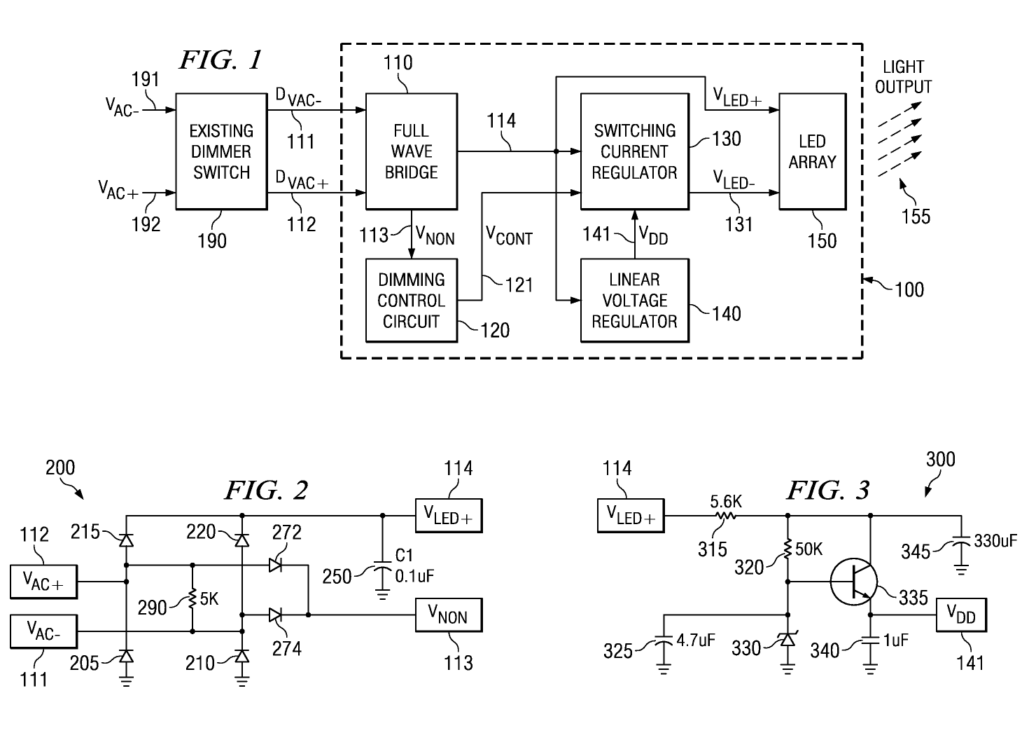

Turning to FIG. 1, a block diagram of a solid state light bulb 100 is shown in relation to an existing incandescent dimmer switch 190 in accordance with various embodiments of the present invention. Solid state light bulb 100 receives a voltage output 111, 112 from existing incandescent dimmer switch 190, and provides a light output 155 that is intensity adjusted based on voltage outputs 111, 112. In particular, existing incandescent dimmer switch 190 receives an AC voltage 191, 192 that is typically 120 VAC. As is known in the art, existing incandescent dimmer switch 190 may then be adjusted to provide either the full scale AC voltage 191, 192 or some attenuated version of AC voltage 191, 192 as voltage outputs 111, 1 12. Thus, voltage outputs 111, 112 that are received by solid state light bulb 100 may vary from a lower voltage up to 120 VAC depending upon the particular type of incandescent dimmer switch, and the switch position of existing incandescent dimmer switch 190.

Solid state light bulb 100 includes a full wave bridge circuit 110, a dimming control circuit 120, a switching current regulator circuit 130, a linear voltage regulator 140, and an LED array 150. Full wave bridge circuit 110 receives voltage outputs 111, 112 are rectifies the received outputs. Based on the disclosure provided herein, one of ordinary skill in the art will recognize a variety of bridges that may be used to condition power received from an existing dimmer switch. The rectified voltage output from full wave bridge circuit 110 is minimally filtered and provided as a voltage output, Vled+ 114 to other circuits of solid state light bulb 100. In addition, the rectified voltage output from full wave bridge circuit 110 is provided unfiltered as a voltage output, Vnon 113, to dimming control circuit 120. Further, full wave bridge circuit 110 provides the basis for a ground, Vled− 131, that is used as a ground reference for LED array 150. Of note, the ground Vled− 131 is floating with respect to earth ground. As discussed in more detail below, Vled− 131 controls the current that is provided to LED array 150, and thereby controls the intensity of light 155 emitted from LED array 150.

Dimming control circuit 120 produces a control voltage, Vcont 121. In some embodiments of the present invention, Vcont 121 varies from approximately 0V to 10V as existing incandescent dimmer switch 190 is varied from its highest to its lowest setting. The setting of existing incandescent dimmer switch 190 is sensed via Vnon 113. As more fully explained below, Vcont 121 controls the intensity of light emitting from LED array 150. In one particular case, when Vcont 121 is at its highest level, the intensity of light emitted from LED array 150 is at its lowest level, and when Vcont 121 is at its lowest level, the intensity of light from LED array 150 is at its greatest.

Switching current regulator circuit 130 receives Vled+ 114 from full wave bridge circuit 110, and provides a Vled− 131 to LED array 150. Vled− 131 controls a current provided to LED array 150, and the current is varied depending upon Vcont 121. In one particular embodiment of the present invention, current passing through Vled− 131 varies from 350 mA to 0 mA, as Vcont 121 ranges from 0V to 10V. Such a range for Vled− 131 is designed to produce the maximum possible intensity when existing incandescent dimmer switch 190 is turned fully on, and the dimmest possible light from LED array 150 when existing incandescent dimmer switch 190 is fully off. Switching current regulator circuit 130 relies on Vdd 141 from linear voltage regulator circuit 140. In one particular embodiment of the present invention, Vdd 141 is nominally 15V. In alternative embodiments of the present invention where a DC voltage is not required, voltage regulator circuit 140 may be eliminated.

LED array 150 includes a group of LEDs arranged in series. LED array 150 is powered by Vled+ 114 that is referenced to Vled− 131 on the negative side. In one particular embodiment of the present invention, LED array 150 includes sixteen LEDs connected in series. Each of the sixteen LEDs drops between 3V and 4V, and thus the maximum voltage differential between Vled+ 114 and Vled− 131 is 64V. Arranging the LEDs in series allows for control of all sixteen LEDs using a single switching current regulator circuit 130.

Turning to FIG. 2, a schematic diagram of a full wave bridge 200 that may be used in relation to one or more embodiments of the present invention is shown. Full wave bridge 200 includes diodes 205, 210, 215, 220 arranged so as to rectify a sinusoidal voltage that is differentially received at voltage inputs 111, 112. In one particular case, diodes 205, 210, 215, 220 are rated at more than 204V so as to accommodate a 120 VAC input signal that varies ±20%.

In operation, voltage inputs 111, 112 would be connected to the voltage outputs from an existing incandescent dimmer switch. The rectified voltage is minimally filtered using a capacitor 250. In one particular embodiment of the present invention, voltage inputs 111, 112 range from 0V to 120 Vrms, and capacitor 250 is a 0.1 uF capacitor. The rectified and filtered voltage is provided as voltage output, Vled+ 114. In operation, voltage output 114 charges capacitor 250 to approximately 50V with a high degree of ripple. The peak ripple voltage will vary as existing dimmer switch is turned down low. Based on the disclosure provided herein, one of ordinary skill in the art will recognize other rectifier circuits that may be used in relation to one or more embodiments of the present invention. Further, one of ordinary skill in the art will recognize a variety of values that may be chosen for capacitor 250. It should be noted, however, that some existing dimmer switches that utilize internal triacs operate better where the load being driven exhibits minimal capacitance.

In addition, full wave bridge circuit 200 provides a non-filtered voltage output, Vnon 113. Vnon 113 is rectified using diodes 272, 274, and is intentionally not peak-detected, but rather left as an AC waveform so that the setting of an existing dimmer switch feeding full wave bridge circuit 200 can be accurately sensed. As the existing dimmer switch is turned to lower settings, the average voltage applied to voltage inputs 111, 112 decreases, even though in some cases the peak voltage may not decrease. A load resistor 290 may be added to allow a potential triac included in an existing dimmer switch to commutate properly. When an incandescent bulb is applied as a load, the resistor is not necessary as the bulb itself provides an adequate resistive load. It should be noted that in some embodiments of the present invention such a load resistor is not included.

Turning to FIG. 3, a schematic diagram of a linear voltage regulator 300 that may be used in relation to one or more embodiments of the present invention is depicted. Linear voltage regulator 300 receives a minimally filtered AC voltage, Vled+ 114, and provides a regulated 15V DC output, Vdd 141. Vdd 141 may be used by various DC circuits including, where applicable, the current source of switching current regulator circuit 130. Linear voltage regulator 300 generates a 15V output using a Zener diode 330 specified to provide 15V±15%. From this, a bipolar transistor 335 is connected as an emitter follower circuit that provides Vdd 141. Linear voltage regulator circuit 330 includes capacitors 325, 340, 345 and resistors 315, 320 configured as shown. The combination of Zener diode 330 biased by resistor 315 and resistor 320 generates a reference voltage that is then buffered using the bipolar transistor 335. The output voltage is equal to the Zener voltage minus one diode drop, or about 14.3V nominal. In some cases, resistor 315 and resistor 320 are selected to bias Zener diode 330 at its minimal Zener current. Resistor 315 and capacitor 345 are used to decouple the linear regulator and hold up the bias to bipolar transistor 335. Capacitor 340 provides decoupling for Vdd 141. Values for the various capacitors and resistors are set forth in FIG. 3. Based on the disclosure provided herein, one of ordinary skill in the art will recognize a variety of values for the various capacitors and resistors that may be used in relation to one or more embodiments of the present invention.

Other transistors may be used in place of bipolar transistor 335, however, bipolar transistor 335 was chosen to make the circuit more efficient and to provide performance even when an existing dimmer switch used to provide Vled+ 114 is generating only 50 VDC peak. The benefit of the series pass source follower regulator is that it provides the required bias current to the control circuit regardless of input voltage, as long as the Zener diode remains biased. The simpler alternative of a Zener shunt regulator will not work as well because it needs to be sized to provide the operating current for the control circuitry at the lowest anticipated Vled+ 114.

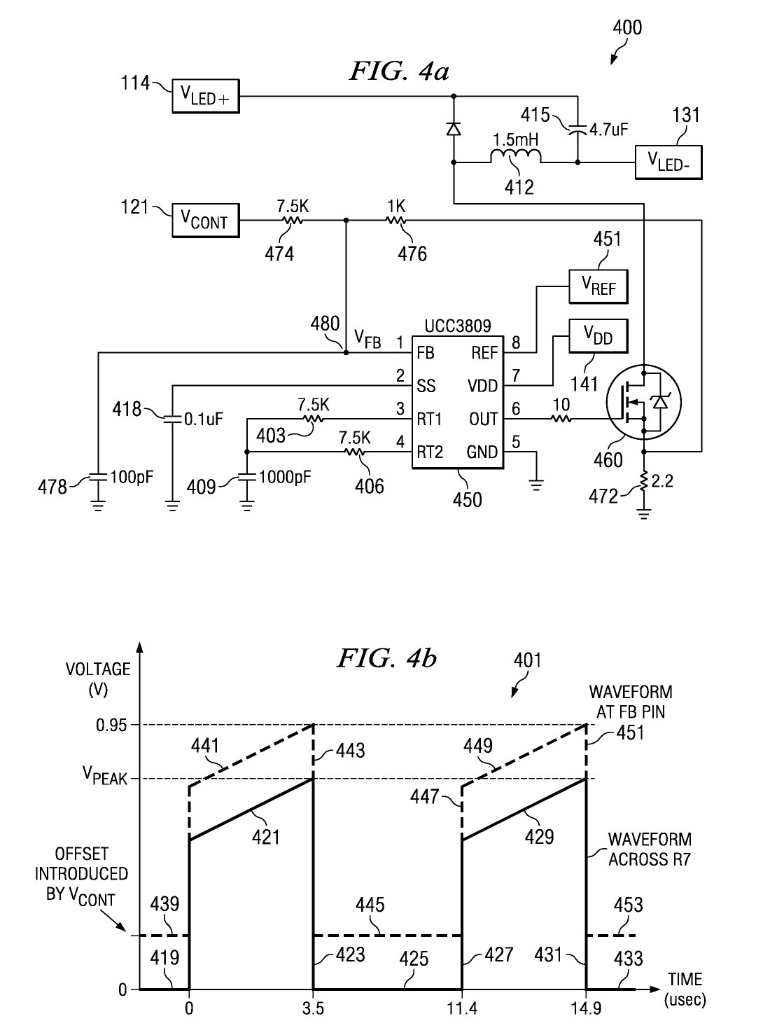

Turning to FIG. 4a, a schematic diagram of a switching current regulator 400 that may be used in relation to on or more embodiments of the present invention is shown. The schematic of FIG. 4 shows the use of a TI-UCC3809 part (element 450 of FIG. 4a) is more fully described in “Economy Primary Side Controller (Rev. B)”, Nov. 19, 2004, by Texas Instruments. The entirety of the aforementioned technical reference document is incorporated herein by reference for all purposes. It should be noted that while the schematic of FIG. 4 shows the use of the TI-UCC3809 part, other current controllers may be used in accordance with other embodiments of the present invention.

Switching current regulator 400 includes an inverted buck converter referenced to a positive input voltage, Vled+ 114. In this case, switching current regulator 400 is referenced to ground, which results in easy MOSFET gate drive and current sensing. Switching current regulator 400 provides voltage output Vled− 131. The operating duty cycle (D) of switching current regulator 400 is equal to the ratio of the output voltage, Vled−, to the input voltage, Vled+. For the case where switching current regulator 400 is driving an LED array consisting of sixteen LEDs, the voltage difference between Vled+ and Vled− would be approximately 51.2V assuming a nominal forward LED voltage of 3.2V. In this case, this results in a worst case duty cycle of between 24% and 47%. Because the duty cycle never goes above 50%, no slope compensation is required.

In one particular embodiment of the present invention, the operating frequency is chosen to be approximately 100 KHz. This choice is based on a compromise between good converter efficiency (lower frequency) and small size (higher frequency). A resistor 403, a resistor 406 and a capacitor 409 are chosen based on the requirements of the UCC3809 as set forth in the previously incorporated reference. As shown, resistor 403 and resistor 406 are each 7.5 kOhm resistors, and capacitor 409 is a 1000 pF capacitor. Based on these values, the UCC3809 operates at a programmed frequency of 88 KHz. In some cases, this frequency is selected such that it is outside any audible range so that the solid state bulbs of the present invention do not make noise. A maximum duty cycle (Dmax) is set to 50% to ensure that the current source remains stable during all operating conditions. The maximum duty cycle is described by the following equation: Dmax=[0.74*(C₄₀₉+27 pF)*(R₄₀₃+R₄₀₆)]* F, where the equation for frequency (F) is set forth below.

Switching current regulator 400 includes an inductor 412 that is selected based on the peak allowable current traversing Vled− 131, and in some cases is directly proportional to the peak energy stored. The peak current traversing Vled− 131 is equal to the average current (0.35 A max) plus one half of the peak-to-peak current. To keep the size of inductor 412 as small as possible, the peak-to-peak current may be chosen to be, for example, 75% of maximum load. This results in an average current traversing inductor 412 when the existing dimmer switch is turned all the way up (i.e., 0.75*0.35 A=0.26 A). The peak-to-peak current in inductor 412 is equal to (Vled+−Vled−)*(1−d)/(f*L). Further, the frequency of operation of the UCC3809 is described by the following equation: F=1/[0.74*(C₄₀₉+27 pF)*R₄₀₃]. Based on the preceding equations, at a switching frequency of 88 KHz and a minimum duty cycle of 25%, the switching cycle is 11.4 usec long and a transistor 460 is on for 3.8 usec of the cycle. This results in a duty cycle of 33%, and an inductor value of approximately 1.5 mH.

A capacitor 415 is selected such that it filters the ripple current traversing inductor 412. In some embodiments of the present invention, a 4.7 uF capacitor is chosen which results in an output ripple voltage of approximately 0.1 Vp-p. Another capacitor 418 determines the time that it takes the UCC3809 to increase the output current to a full programmed current. Before switching current regulator is started, capacitor 418 is held low by the UCC3809. When Vdd 141 rises above an under-voltage condition, capacitor 418 is charged using a 6 uA current source internal to the UCC3809. While the voltage on capacitor 418 is less than approximately 1V the UCC3809 remains off and does not produce any output pulses. As capacitor 418 ramps from 1V to 2V, the UCC3809 gradually allows the output pulse width to increase up to the programmed pulse width discussed above.

In one particular embodiment of the present invention, an initial startup period of 30ms is chosen. While this amount of time allows the various control circuitry to settle to the steady state value before the current source starts up, one of ordinary skill in the art will recognize a variety of other times that may be selected based on the needs of a particular design. Capacitor 418 is selected based on the following equation from the previously incorporated reference:

C=dt/dV*I=30 ms/2.0V*6 uA=0.1 uF.

A feedback circuit including a resistor 472 operates as a sense resistor that creates a voltage directly proportional to the drain current of transistor 460 when transistor 460 is turned on. The feedback circuit further includes a resistor 474, a resistor 476 and a capacitor 478 driving a feedback node 480 of the UCC3809. In the feedback circuit, a feedback from resistor 472 is summed with Vcont 121 at feedback node 480. The voltage at feedback node 480 is described by the equation:

$$Vfb = ( \frac{Vcont}{{R}_{474}} - \frac{Iq 1 * {R}_{472}}{{R}_{476} + {R}_{472}} ) * ( \frac{( {R}_{476} - {R}_{472} ) * {R}_{476}}{{R}_{476} + {R}_{472} + {R}_{476}} ) ,$$

where Iq1 is the current passing through the drain of transistor 460. The voltage at feedback node 480, Vfb, is compared by the UCC3809 with a fixed internal threshold of 0.95. At the beginning of the switching cycle, transistor 460 is turned on and the current in traversing transistor 460 increases as voltage is being applied to inductor 412.

FIG. 4b shows a graphical plot 401 of the voltage at feedback node 480 and the voltage across resistor 472 as a function of time. As shown in graphical plot 401, the voltage at feedback node 480 includes segments 439, 441, 443, 445, 447, 449, 451, 453; and the voltage across resistor 472 includes segments 419, 421, 423, 425, 427, 429, 431, 433. In operation, when the voltage at feedback node 480 crosses the 0.95V internal threshold of the UCC3809, transistor 460 turns off until the next switching cycle is initiated based on the internal clock of UCC3809. As discussed above, in one particular embodiment of the present invention, the switching cycle is 11.4 usec long. By substituting 0.95V for Vfb in the equation set forth above and performing some algebraic manipulation, the following equation for Iq1 is derived:

$$Iq 1 ( peak ) = ( \frac{0.95 V}{{R}_{472}} * \frac{{R}_{476} + {R}_{474}}{{R}_{474}} ) - Vcont * \frac{{R}_{476}}{{R}_{474}} .$$

The preceding equation demonstrates that the peak current of transistor 460 is programmable as a function of Vcont 121, such that when Vcont 121 is zero the maximum current is programmed. The current decreases as Vcont 121 is increased. Ultimately, the current is zero where Vcont=(R₄₇₄/R₄₇₆)*0.95V.

Thus, in operation, the UCC3809 turns transistor 460 on at the beginning of the switching cycle (T=0 usec). At this point, the voltage across resistor 472 jumps to a determined value and begins to increase as a function of inductor 412. The voltage across resistor 472 continues to increase until the voltage at feedback node 480 reaches the 0.95V internal threshold of the UCC3809 (T=3.5 usec). At this point, UCC3809 turns transistor 460 off, and the voltage across resistor 472 returns to zero volts until the end of the 11.4 us switching cycle (T=11.4 usec). At this point, the process is repeated for another 11.4 usec switching cycle. As can be seen from the plot of FIG. 4b, the “on time” of transistor 460 is increased where the value of Vcont 121 is reduced as it takes longer for the 0.95V internal threshold to be reached. In contrast, the 0.95V internal threshold is achieved more quickly and thus the “on time” of transistor 460 is reduced where the value of Vcont 121 is increased. The period at which transistor 460 is turned on dictates the current that traverses Vled− 131.

It should be noted that the relationship between the average current supplied via Vled− 131 and Vcont 121 is complicated because at lower currents inductor 412 becomes discontinuous. Discontinuous refers to the condition where the inductor current reaches zero during the switching cycle. This occurs when the average output current is less than or equal to one half of the peak-to-peak current in the inductor, or 0.13A in this example. For average LED currents greater than 0.13A the relationship between Vcont 121 and the traversing Vled− 131 is linear. For currents less than 0.13 A, the current traversing Vled− 131 drops proportional to the square of (Vmax-Vcont). Although somewhat non-linear, this represents a smooth control of diode forward current through the operating range of the dimmer control.

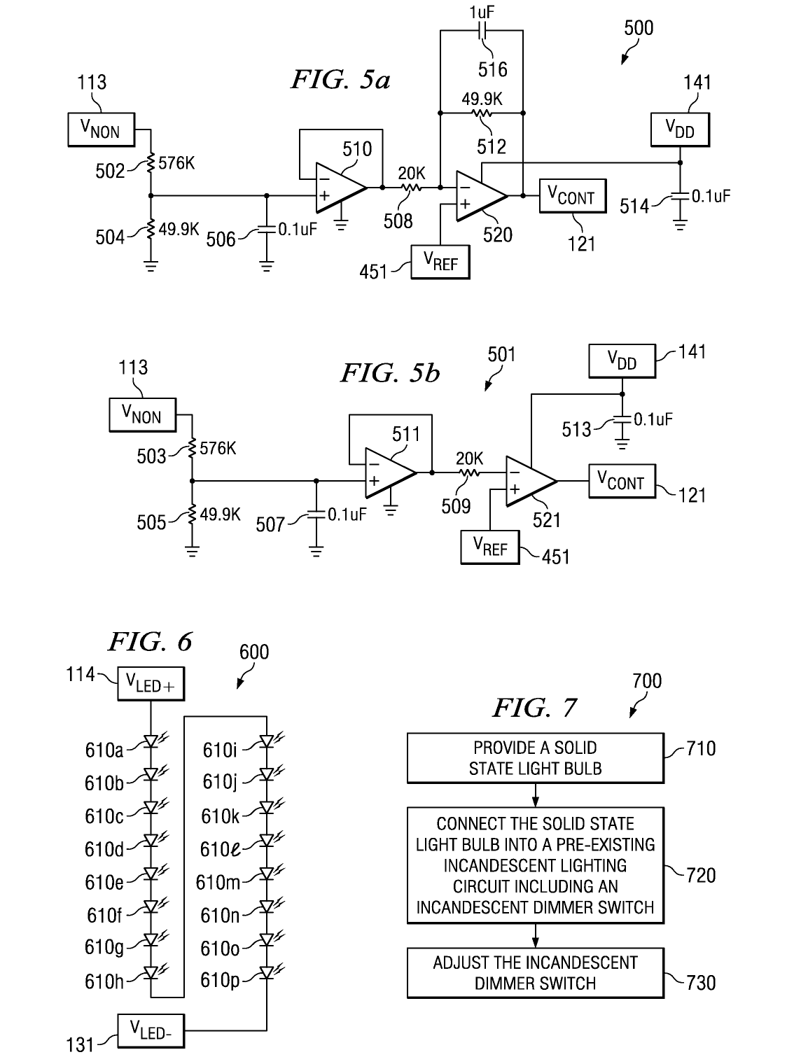

Turning to FIGS. 5a-5b schematic diagrams of dimming control circuits 500, 501 that may be used in relation to various embodiments of the present invention are shown. Referring first to dimming control circuit 500 of FIG. 5a, rectified voltage, Vnon 113, representing the state of the existing dimmer switch is level shifted through division between a resistor 502 and a resistor 504. As discussed above, the sinusoidal voltage provided from an existing dimmer switch is rectified, and has an average theoretical value of 0.707 times the peak value of the sine wave, or 120V nominal when the existing dimmer switch is turned all the way on. This input voltage is attenuated using the aforementioned divider circuit so that it is at a level that operational amplifier 510 can follow. In this way, the solid state light bulb can sense the setting of the dimmer switch. The attenuated voltage is low pass filtered using a capacitor 506 in combination with resistors 502, 504, and then averaged by operational amplifier 510. The output of operational amplifier 510 is provided to another operational amplifier 520 via a resistor 508.

Operational amplifier 520 is configured with a resistor 512 and a capacitor 516 in a feedback loop. Operational amplifier 520 performs additional averaging of the input voltage signal, and provides an output DC voltage, Vcont 121, that is indicative of the setting of the existing dimmer switch that feeds dimming control circuit 500. In the depicted implementation of dimming control circuit 500, the various resistors and capacitors are selected such that the output of operational amplifier 510 varies between 2V and 8V depending upon the position of the existing dimmer switch. Operational amplifier 520 provides a level shift based on a comparison with Vref 451, and a gain. In the depicted circuit, the gain is 2.5, and a low pass filter is implemented with a time constant of 3.2 Hz is selected to filter the 120 Hz rectified signal as much as possible, without introducing too much delay, which a human might notice (50 msec time constant or less). The gain is set by the ratio of resistor 512 to resistor 508. The time constant is set by the product of capacitor 516 and resistor 512.

Turning to FIG. 5b, an alternative dimming control circuit 501 is discussed. Dimming control circuit 501 receives rectified voltage, Vnon 113, representing the state of the existing dimmer switch is level shifted through division between a resistor 503 and a resistor 505. Again, as discussed above, the sinusoidal voltage provided from an existing dimmer switch is rectified, and has an average theoretical value of 0.707 times the peak value of the sine wave, or 120V nominal when the existing dimmer switch is turned all the way on. This input voltage is attenuated using the aforementioned divider circuit so that it is at a level that operational amplifier 511 can follow. In this way, the solid state light bulb can sense the setting of the dimmer switch. The attenuated voltage is low pass filtered using a capacitor 507 in combination with resistors 503, 505, and then averaged by operational amplifier 511. The output of operational amplifier 511 is provided to another operational amplifier 521 via a resistor 509.

In contrast to dimming control circuit 500, operational amplifier 521 is configured without feedback and operates as a digital comparator. Thus, instead of the DC output voltage provided by the previously described circuit, dimming control circuit 501 provides a pulse width modulated version of Vcont 121. When averaged, the pulse width modified version of Vcont 121 provides the same 0V to 10V range of the previously described circuit. Experimentation revealed that while the average voltage for Vcont was the same for both circuits, there was a noticeable color difference in the light produced from the solid state bulb depending upon which of the dimming control circuits 500, 501 were used. Preliminary analysis revealed that the light emitted during a pulse width modulated operation was more pleasant and offered a more natural light.

Turning to FIG. 6 an LED array 600 that may be used in relation to different embodiments of the present invention is depicted. LED array 600 includes sixteen LEDs 610 connected serially with the first LED 610a in the serial chain being connected to Vled+ 114, and the last LED 610p in the serial chain being connected to Vled− 131. By arranging LEDs 610 serially, only a single current passing from Vled+ 114 to Vled− 131 needs to be regulated.

Turning to FIG. 7, a flow diagram 700 shows a method for retrofitting lighting in accordance with various embodiments of the present invention. Following flow diagram 700, a solid state light bulb similar to that described in relation to FIG. 1 above is provided (block 710). This bulb is then used to replace an existing incandescent light bulb by connecting the solid state bulb into a pre-existing lighting circuit that was designed to handle incandescent bulbs (block 720). In particular, the solid state bulb is connected to an existing incandescent dimmer switch that is designed to provide a variable voltage as a function of switch position. Once installed, the existing incandescent dimmer switch is adjusted (block 730). As discussed above, adjusting the existing incandescent dimmer switch produces an AC output voltage with an average voltage that reflects the switch position. This voltage is provided to the solid state light bulb where it is converted to a variable current. The variable current drives an LED array included in the solid state light bulb to produce light. The intensity of the produced light is a function of the produced current, which is in turn a function of the position of the existing incandescent dimmer switch. It should be noted that, among other things, either a DC voltage controlled solid state light bulb may be used, or a pulse width modulated solid state light bulb.

In conclusion, the present invention provides novel systems, devices, methods for LED based lighting. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A backwards compatible solid state light bulb, the bulb comprising:
an LED array;
a dimming control circuit; and
a current regulator, wherein the current regulator provides an LED current to the LED array, and wherein the LED current varies based on a control from the dimming control circuit.

2. The bulb of claim 1, wherein the dimming control circuit is operable to receive a voltage output from an incandescent dimmer switch and to provide the control based on the voltage output from the incandescent dimmer switch.

3. The bulb of claim 2, wherein the control is a DC voltage, and wherein the DC voltage is proportional to the voltage output from the incandescent dimmer switch.

4. The bulb of claim 3, wherein the proportionality of the DC voltage to the voltage output from the incandescent dimmer switch is selected from a group consisting of: inverse proportionality and direct proportionality.

5. The bulb of claim 3, wherein the DC voltage varies between 0V and 10V.

6. The bulb of claim 3, wherein the bulb further includes a full wave bridge, and wherein the full wave bridge rectifies the voltage output from the incandescent dimmer switch before the voltage output from the incandescent dimmer switch is provided to the dimming control circuit.

7. The bulb of claim 2, wherein the control is a pulse width modulated output, and wherein the duty cycle of the pulse width modulated output is proportional to the voltage output from the incandescent dimmer switch.

8. The bulb of claim 1, wherein the LED array includes a plurality of serially connected LEDs, and wherein a single current source drives the plurality of serially connected LEDs.

9. The bulb of claim 8, wherein the plurality of serially connected LEDs includes a series of sixteen LEDs.

10. A method for retrofitting lights, the method comprising:
providing a solid state light bulb, wherein the solid state light bulb includes:
an LED array;
a dimming control circuit; and
a current regulator, wherein the current regulator provides an LED current to the LED array, and wherein the LED current varies based on a control from the dimming control circuit;
electrically coupling the solid state light bulb to an existing incandescent dimmer switch; and
adjusting the existing incandescent dimmer switch, wherein light emitted from the LED array is adjusted in proportion to the adjustment of the existing incandescent dimmer switch.

11. The method of claim 10, wherein adjusting the existing incandescent dimmer switch causes the existing incandescent dimmer switch to output a voltage that varies up to 120 VAC.

12. The method of claim 10, wherein the dimming control circuit is operable to receive a voltage output from the existing incandescent dimmer switch and to provide the control based on the voltage output from the incandescent dimmer switch.

13. The method of claim 12, wherein the solid state light bulb further includes a full wave bridge, and wherein the full wave bridge rectifies the voltage output from the existing incandescent dimmer switch before the voltage output from the existing incandescent dimmer switch is provided to the dimming control circuit.

14. The method of claim 13, wherein the control is a DC voltage, and wherein the DC voltage is proportional to the voltage output from the existing incandescent dimmer switch.

15. The method of claim 14, wherein the proportionality of the DC voltage to the voltage output from the existing incandescent dimmer switch is selected from a group consisting of: inverse proportionality and direct proportionality.

16. The method of claim 13, wherein the control is a pulse width modulated output, and wherein the duty cycle of the pulse width modulated output proportional to the voltage output from the existing incandescent dimmer switch.

17. The method of claim 16, wherein the proportionality of the pulse width modulated output to the voltage output from the existing incandescent dimmer switch is selected from a group consisting of: inverse proportionality and direct proportionality.

18. The method of claim 10, wherein the LED array includes a plurality of serially connected LEDs, and wherein a single current source drives the plurality of serially connected LEDs.

19. The method of claim 18, wherein the plurality of serially connected LEDs includes a series of sixteen LEDs.

20. An incandescent dimmer switch compatible solid state light bulb, wherein the solid state light bulb comprises:
an LED array, wherein the LED array includes a series of serially connected LEDs, and wherein a single current regulat drives the plurality of serially connected LEDs;
a dimming control circuit, wherein the dimming control circuit provides a control output that is proportional to a voltage output from an incandescent dimmer switch, and wherein the control is selected from a group consisting of: a variable DC voltage and a pulse width modulated output; and
a current regulator, wherein the current regulator provides an LED current to the plurality of serially connected LEDs, and wherein the LED current varies based on the control from the dimming control circuit.
